(19) United States
(12) Patent Application Publication
(10) Pub. No.: US 2010/0213136 A1
(43) Pub. Date: Aug. 26, 2010

(54) APPARATUS FOR MOVING MAGNETIC PARTICLES

(75) Inventors: Adrianus Wilhelmus Dionisius Maria Van Den Bijgaart, Eindhoven (NL); Ronald Cornelis De Gier, Eindhoven (NL); Antonius Fransiscus Johannes De Groot, Eindhoven (NL); Chris Van Haag, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,950

(22) PCT Filed: Jun. 19, 2006
(86) PCT No.: PCT/IB06/51955

§ 371 Date: Dec. 18, 2007

(30) Foreign Application Priority Data
Jun. 23, 2005 (EP) 05105603.4

(51) Int. Cl. B03C 1/02

(52) U.S. Cl. 210/695; 210/222

(57) ABSTRACT

The invention provides an apparatus for moving magnetic particles in a liquid medium, a system comprising an apparatus, a method for moving magnetic particles and a method for moving and for fixing the magnetic particles. The apparatus comprises a first magnetic means generating a first magnetic field, the apparatus further comprising a second magnetic means generating a second magnetic field, the first magnetic field having a first main axis, the second magnetic field having a second main axis, wherein the first and second main axes are inclined relative to each other by an acute angle of inclination.

The present invention relates to an apparatus for moving magnetic particles in a liquid medium. The present invention further relates to a system for moving magnetic particles in liquid medium, the system comprising an apparatus and a chamber. The present invention further relates to a method for moving magnetic particles and to a method for moving and for fixing the magnetic particles.

In the field of analysis of biological samples, especially molecular diagnostic as well as nucleic acid analysis, and in particular analysis by isolation of nucleic acid from biological or clinical specimen, there exists a need for an enhanced degree of automation because, e.g. the isolation of nucleic acid from biological samples can be time-consuming and tedious. Sample preparation might include cell isolation, cell lysis and washing. For genetic analysis regarding genetic-based disease, conditions or characteristics, it is essential to have available a reliable, easily reproduced method of nucleic acid isolation, particularly one that is amenable to automation. This requirement is particularly useful for detection of specific bacterial DNA in low concentrations in a body fluid of a patient.

In this context, it is usually necessary to process magnetic particles like magnetic beads provided with special binding molecules performing e.g. binding reactions with compounds present in the sample fluid. For that reason, a controllable fluid-bead interaction is necessary to achieve so that

it is possible to bind e.g. the beads to certain target molecules,

it is further possible to wash or to separate or to elute the targets or compounds located at the magnetic beads or particles from the residual fluid.

Apparatus for moving magnetic particles by applying a magnetic field on a container or a chamber containing the magnetic particles together with a medium like a liquid are generally known. For example, international patent application WO 04/000446 A2 discloses a method and arrangement of rotating magnetically inducible particles. This document discloses a devices and method for rotating magnetically inducible particles suspended in a fluid by rotating a multidirectional magnetic field through the suspended particles, whereby the particles and the fluid are moved. It has been realized that in prior art apparatus for moving magnetic particles the efficiency of moving in relation to the application of shear forces to the medium or the compounds in the medium is unsatisfying.

It is therefore an object of the present invention to provide an apparatus for moving magnetic particles in a liquid medium provided in a chamber that has a high degree of moving efficiency as well as an optimum value of shear force application to the compounds in the medium.

The above object is accomplished by an apparatus, a system, a method for moving and a method for moving and for fixing according to the present invention. The apparatus for moving magnetic particles in a liquid medium provided in a chamber comprises a first magnetic means generating a first magnetic field, the apparatus further comprises a second magnetic means generating a second magnetic field, the first magnetic field having a first main axis, the second magnetic field having a second main axis, wherein the first and second main axes are inclined relative to each other by an acute angle of inclination.

An advantage of the apparatus according to the invention is that by applying the magnetic fields of the two magnetic means in such a way, a more effective moving of the magnetic particles in the medium is possible. For biochemical reaction involving biological molecules, e.g. nucleic acids, oligo nucleic acids, proteins, antibodies and the like, a better binding of corresponding molecules or in general a better biochemical reaction can be achieved if the magnetic particles or beads move through the fluid in such a way that they see as much of the medium or of the fluid surface as possible within a predetermined time interval. By applying the magnetic fields of the two magnetic means with inclined main axes of the magnetic means, also the moving during a washing step after a biochemical reaction has taken place is made more efficient. It is assumed that the moving efficiency is related to the visual turbulence of the magnetic beads or magnetic particles. The more turbulence observed, the better the binding and/or the washing process.

In a preferred embodiment of the present invention the first magnetic means is provided rotatable at a first speed of rotation about a first axis of rotation and wherein the second magnetic means is provided rotatable at a second speed of rotation about a second axis of rotation. It is especially preferred that the first and the second speed of rotation are provided changeable during moving operation. This has the advantage that the first magnetic means and the second magnetic means can be moved independently and with variable speed, so that the moving efficiency of the magnetic particles is enhanced. The magnetic field that the magnetic particles “see” inside the chamber is thereby enhanced. It is also possible to operate different volumes and types of fluid by changing the first and/or second speed of rotation and by changing the direction of rotation and/or by the height (or distance) of the first and/or second magnet relative to the chamber.

In a still further preferred embodiment of the present invention the first and second axis of rotation coincide. This feature has the advantage that the inventive apparatus can be constructed more simply and cost-effectively.

In a preferred embodiment of the present invention the first magnetic means is provided in a first distance to the chamber and wherein the second magnetic means is provided in a second distance to the chamber. It is especially preferred that the first and the second distance are provided independently changeable during operation of the apparatus. An advantage of the apparatus according to the present invention is that it is possible to precisely control the magnetic forces that act on the magnetic particles. It is also possible to operate different volumes and types of fluid by changing the first and/or second distance. By changing also the (first and/or second) speed of rotation and the (first and/or second) distance it is possible to operate an even greater range of differently sized fluid samples and/or fluids of different types. The speed of rotation and/or the distance is preferably defined as a function of the viscosity of the liquid medium and the volume of the liquid medium to be treated by the inventive apparatus.

In a still further preferred embodiment of the present invention the angle of inclination is provided changeable during moving operation. It is especially preferred that the angle of inclination is in the range of 20° to 70° and most preferably in the range of 35° to 55°.

In a preferred embodiment of the present invention the first and/or the second magnetic means are permanent magnets. An advantage of the apparatus according to the present invention is that the apparatus can be made light weight and cost-efficiently by using standard magnetic elements as magnetic means. Alternatively, the magnetic means can also be provided as electromagnets. This has the advantage that the strength and the form of the magnetic field can be varied during the process of moving the magnetic particles through the medium.

In a preferred embodiment of the present invention the first magnetic means is provided above the chamber and the second magnetic means is provided below the chamber. An advantage of the apparatus according to the present invention is that it is possible to use it with disposable cartridges carrying the chamber with the magnetic particles and the medium inside.

The present invention also includes a system for moving magnetic particles in a liquid medium, the system comprising an apparatus, the system further comprising a chamber where the magnetic particles are located, the apparatus comprising a first magnetic means generating a first magnetic field, the apparatus further comprising a second magnetic means generating a second magnetic field, the first magnetic field having a main axis, the second magnetic field having a second main axis, wherein the first and second main axes are inclined relative to each other by an acute angle of inclination, wherein the chamber is provided with an inlet and an outlet. The system according to the invention comprises the inventive apparatus and the chamber. It is preferred that the chamber is located inside a disposable cartridge which can be inserted or taken out of the apparatus by means, e.g. of a slot or the like. It is thereby possible that the medium inside the chamber can be completely isolated from the apparatus and that the system realizes a closed system regarding the medium and the magnetic particles. Inside the cartridge, the chamber is preferably linked to other compartments like mixing chambers, reservoirs or the like. The chamber communicates with these other compartments by means of an inlet and an outlet.

The present invention also includes a method for moving magnetic particles, the magnetic particles being provided in a liquid medium provided in a chamber, the method comprising the following steps:

rotating a first magnetic means generating a first magnetic field about a first axis of rotation with a first speed of rotation, the first magnetic field having a first main axis,

rotating a second magnetic means generating a second magnetic field about a second axis of rotation with a second speed of rotation, the second magnetic field having a second main axis,

wherein the first and second main axes are inclined relative to each other by an acute angle of inclination. Thereby, the efficiency of moving the magnetic particles can be greatly enhanced.

In a preferred embodiment of the present invention the first and the second speed of rotation are changed during the moving of the magnetic particles through the medium. This has the advantage that the first magnetic means and the second magnetic means can be moved independently and with variable speed during the application of the magnetic forces, so that the moving efficiency of the magnetic particles is enhanced. The magnetic field that the magnetic particles “see” inside the chamber is thereby further enhanced.

The present invention also includes a method for moving magnetic particles in a liquid medium and for fixing the magnetic particles, wherein

in a first step the magnetic particles are moved by the inventive method and wherein

in a second step the magnetic particles are fixed by reducing the first distance of the first magnetic means to the chamber and by increasing the second distance of the second magnetic means from the chamber. The method according to the present invention has the advantage that it is possible to accumulate and fix the magnetic particles in a small volume of the chamber. In this situation, the magnetic particles are immobilized e.g. at an upper limitation (“ceiling”) of the chamber. The medium can then be expulsed from the chamber, so that it is possible to wash and rise the materials or compound attached to the magnetic particles or magnetic beads.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

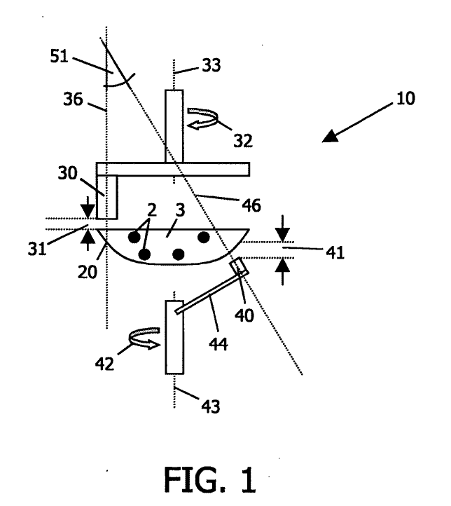

FIG. 1 illustrates schematically an inventive apparatus together with a chamber.

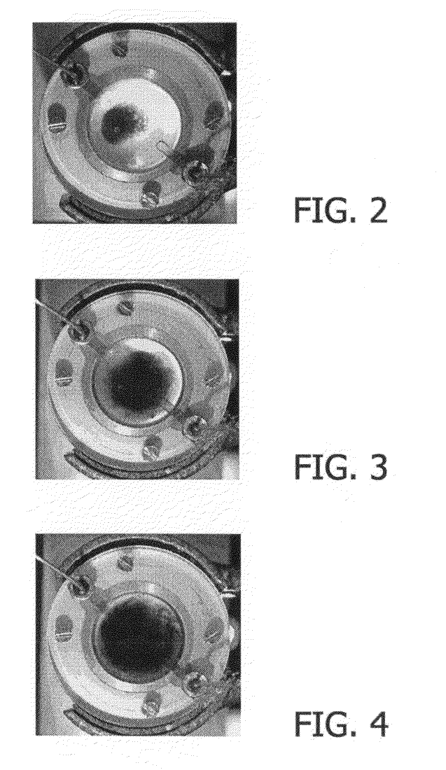

FIGS. 2 to 4 illustrate views of the chamber with examples of the moving or mixing efficiency at different speeds of rotation of the magnetic means.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noted that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIG. 1 an inventive apparatus 10 together with a chamber 20 is schematically illustrated. The chamber contains the medium 3 and the magnetic particles 2. The apparatus 10 comprises a first magnetic means 30 above the chamber 20 and a second magnetic means 40 below the chamber 20. The first magnetic means 30 is positioned rotatable about a first axis of rotation 33 and the second magnetic means 40 is positioned rotatable about a second axis of rotation 43. The first magnetic means 30 can be rotated at a first speed of rotation 32 about the first axis of rotation 33 and the second magnetic means 40 can be rotated at a second speed of rotation 42 about the second axis of rotation 43. The first magnetic means 30 is provided at a first distance 31 from the chamber 20 and the second magnetic means 40 is provided at a second distance 41 from the chamber 20.

The first magnetic means 30 and the second magnetic means 40 are preferably permanent magnets, e.g. an alloy of rare earths. The magnetic field external to such a permanent magnet or “generated” by such a permanent magnet shows usually a rotational symmetry or at least an approximation thereof with a main axis. In the case of a n homogeneous material permanent magnet in the form of a round disk the external magnetic field shows a rotational symmetry and the main axis goes through the center of the disk and is directed orthogonal to the main plane of the disk. For a differently shaped permanent magnet, the main axis will usually also run through the center of the magnet. The main axis according to the present invention usually coincides with the direction of the magnetic field external to the magnet at a surface portion of the magnet where the magnetic field is directed rectangular to the surface portion of the magnet. In this way, also the first magnetic means 30 show a first main axis 36 and the second magnetic means 40 shows a second main axis 46. According to the present invention, the main axes 36, 46 of the first and second magnetic means 30, 40 are inclined relative to each other by an acute angle of inclination 51. It is thereby possible to greatly vary and control the magnetic field that the first and second magnetic means 30, 40 produce inside the chamber 20.

Preferably, the magnetic means 30, 40 as permanent magnet have a rectangular cross-section and may be glued or otherwise fixed by mechanical means to a rotatable non-magnetic holding support to form a permanent magnet assembly. For the second magnetic means 40, a holding support 44 is represented in FIG. 1. The assembly may include a ferromagnetic harness to house the magnet or magnets and to focus the magnetic field.

In the case of the illustrated example of the inventive apparatus 10 with a vertical first axis of rotation 33 and an inclined holding support 44 for the second magnetic means 40, the angle of inclination 51 corresponds preferably to the acute angle between the vertical first rotational axis 33 and the inclined holding support 44 for the second magnetic means 40, i.e. the second main axis 46 runs e.g. perpendicular to the holding support 44 for the second magnetic means 40.

In FIGS. 2 to 4 views of the chamber 20 taken from the top the chamber 20 with examples of the moving or mixing efficiency at different speeds of rotation of the magnetic means 30, 40 are shown. For the sake of clarity, the second magnetic means 40 is not shown in FIGS. 2 to 4. In FIG. 2, the magnetic particles 2 move only slowly (approximately at 2 revolutions per second), whereas in FIG. 3, the magnetic particles 2 are moved with an average speed (approximately at 6 revolutions per second). As can be seen by comparing FIGS. 2 and 3, by rotating the magnetic particles more quickly, a higher degree of visual turbulence (dark area) is achieved. In FIG. 4, an even higher degree of visual turbulence is achieved while moving the magnetic means 30, 40 at an even higher speed of rotation (faster than approximately 9 revolutions per second).

According to the present invention, it is possible to move or mix the magnetic particles 2 provided in the medium 3 inside the chamber 20 by means of the magnetic means 30, 40. According to the invention, a controlled stirring of magnetic particles 2 through a fluid or through a medium is possible.

The magnetic particles 2 are preferred as magnetic beads 2, magnetic labels 2 or magnetic spheres 2. The magnetic particles 2 are designed to be able to carry binding sites at which target molecules, e.g. nucleic acids can bind. The magnetic particles 2 can be provided magnetized or magnetizable. The magnetic particles 2 do not necessarily be spherical in shape, but may be of any suitable shape, e.g. in the form of spheres, cylinders or rods, cubes, ovals etc. or may have no defined or constant shape. The term “magnetic particles” is understood to mean that the particles include any suitable form of one magnetic material or more magnetic material, e.g. magnetic, diamagnetic, paramagnetic, superparamagnetic, ferromagnetic, that is any form of magnetism which generates a magnetic dipole in a magnetic field, either permanently of temporarily. For performing the present invention, there is no limitation to the shape of the magnetic particles, but spherical particles are at present the easiest and cheapest to manufacture in a reliable way. The size of the magnetic particles is not per se a limiting factor of the present invention. However, for detecting interactions in a microfluidic system, small sized magnetic particles will be advantageous. When micrometer-sized magnetic beads are used as magnetic particles, they limit the downscaling. Furthermore, small magnetic particles 2 have better diffusion properties and generally show a lower tendency to sedimentation than large magnetic particles 2. According to the present invention, magnetic particles are used in the size range between 1 and about 5000 nm, more preferably between about 600 and about 4000 nm.

The movement of the magnetic particles 2 through the medium 3 can be controlled by means of rotating the first and/or second magnetic means 30, 40 at different speeds of rotation. The movement of the magnetic particles 2 through the medium 3 can further be controlled by means of rotating the first magnetic means 30 in the same or in opposite direction of rotation compared to the second magnetic means 40. The movement of the magnetic particles 2 through the medium 3 can still further be controlled by varying the first and second distances 31, 41 of the magnetic means 30, 40 relative to the chamber 20.

In addition to moving the magnetic particles 2 through the medium 3 inside the chamber 20, the magnetic means can also be used to fix or to trap the magnetic particles 2 at a location inside the chamber preferably at an inner surface area of the chamber 20. This is done for example by lowering the first and second magnetic means 30, 40, i.e. by reducing the first distance 31 and by increasing the second distance 41. Then the magnetic particles 2 accumulate in a small volume and the most of the fluid of the medium 3 can be flushed out of the chamber 20. Of course, it is also possible to trap or fix the magnetic particles by raising the first and second magnetic means 30, 40, i.e. by increasing the first distance 31 and by reducing the second distance 41.

1. Apparatus (10) for moving magnetic particles (2) in a liquid medium (3) provided in a chamber (20), the apparatus (10) comprising a first magnetic means (30) generating a first magnetic field (35), the apparatus (10) further comprising a second magnetic means (40) generating a second magnetic field (45), the first magnetic field (35) having a first main axis (36), the second magnetic field (45) having a second main axis (46), wherein the first and second main axes (36, 46) are inclined relative to each other by an acute angle of inclination (51).

2. Apparatus (10) according to claim 1, wherein the first magnetic means (30) is provided rotatable at a first speed of rotation (32) about a first axis of rotation (33) and wherein the second magnetic means (40) is provided rotatable at a second speed of rotation (42) about a second axis of rotation (43).

3. Apparatus (10) according to claim 2, wherein the first and second axis of rotation (33, 43) coincide.

4. Apparatus (10) according to claim 2, wherein the first and second speed of rotation (32, 42) are provided changeable during a moving operation.

5. Apparatus (10) according to claim 1, wherein the first magnetic means (30) is provided in a first distance (31) to the chamber (20) and wherein the second magnetic means (40) is provided in a second distance (41) to the chamber (20).

6. Apparatus (10) according to claim 5, wherein the first and the second distance (31, 41) are provided independently changeable during operation of the apparatus.

7. Apparatus (10) according to claim 1, wherein the angle of inclination (51) is provided changeable during moving operation.

8. Apparatus (10) according to claim 1, wherein the angle of inclination (51) is in the range of 20° to 70°.

9. Apparatus (10) according to claim 1, wherein the angle of inclination (51) is in the range of 35° to 55°.

10. Apparatus (10) according to claim 1, wherein the first and/or the second magnetic means (30, 40) are permanent magnets.

11. Apparatus (10) according to claim 1, wherein the first magnetic means (30) is provided above the chamber (20) and wherein the second magnetic means (40) is provided below the chamber (20).

12. System for moving magnetic particles (2) in a liquid medium (3), the system comprising an apparatus (10), the system further comprising a chamber (20) where the magnetic particles (2) are located, the apparatus comprising a first magnetic means (30) generating a first magnetic field (35), the apparatus (10) further comprising a second magnetic means (40) generating a second magnetic field (45), the first magnetic field (35) having a main axis (36), the second magnetic field (45) having a second main axis (46), wherein the first and second main axes (36, 46) are inclined relative to each other by an acute angle of inclination (51), wherein the chamber (20) is provided with an inlet (21) and an outlet (22).

13. Method for moving magnetic particles (2), the magnetic particles (2) being provided in a liquid medium (3) provided in a chamber (20), the method comprising the following steps of
rotating a first magnetic means (30) generating a first magnetic field (35) about a first axis of rotation (33) with a first speed of rotation (32), the first magnetic field (35) having a first main axis (36),
rotating a second magnetic means (40) generating a second magnetic field (45) about a second axis of rotation (43) with a second speed of rotation (42), the second magnetic field (45) having a second main axis (46),
wherein the first and second main axes (36, 46) are inclined relative to each other by an acute angle of inclination (51).

14. Method according to claim 13, wherein the first and second speed of rotation (32, 42) are changed during moving.

15. Method for moving magnetic particles (2) in a liquid medium (3) and for fixing the magnetic particles (2), wherein
in a first step the magnetic particles (2) are moved by a method according to claim 13 and wherein
in a second step the magnetic particles (2) are fixed by reducing a first distance (31) of the first magnetic means (30) to the chamber (20) and by increasing a second distance (41) of the second magnetic means (40) from the chamber (20).
